(19) United States
(12) Patent Application Publication
(10) Pub. No.: US 2006/0265383 A1
(43) Pub. Date: Nov. 23, 2006

(54) Method and system for performing and sorting a content search

(75) Inventors: Peter Pezaris, Delray Beach, FL (US); Michael Gersh, Maplewood, NJ (US)

Correspondence Address: PEPPER HAMILTON LLP, ONE MELLON CENTER, 50TH FLOOR, 500 GRANT STREET, PITTSBURGH, PA, 15219, US

(73) Assignee: Pezaris Design, Inc.

(21) Appl. No.: 11/131,593

(22) Filed: May 18, 2005

(51) Int. Cl. G06F 17/30

(52) U.S. Cl. 707/10

(57) ABSTRACT

A method and system for searching for content are disclosed. One or more search terms may be received from a user. The search term(s) may be received by, for example, a computer system. A plurality of information items may then be selected from, for example, a database. Each selected information item may include at least one search term received from the user. For at least one selected information item, a content supplier for the information item and a relationship index between the user and the content supplier may be determined. The selected information items may be ordered, at least in part, based upon the relationship index determined for the information item. A representation of at least one of the ordered information items may then be displayed to, for example, the user.

### TECHNICAL FIELD

The embodiments disclosed herein generally relate to methods and systems for content searching. The embodiments particularly relate to methods and systems for performing a content search and sorting the results.

### BACKGROUND

The introduction of the Internet has provided a medium for interacting with others. Chat rooms, message boards, and interactive Web sites each provide the opportunity for people to meet other people and expand their social networks. Moreover, information may be transmitted from one person to another over the Internet by accessing information posted on a Web site or by sending an e-mail message to another person's e-mail address. Because the Internet allows users to interact with individuals that are remotely located, the Internet can provide a powerful tool in expanding one's social network.

It is well known that computer systems can be used to index databases, and to search the index to locate records qualified by queries. Web searching, described below, is one example of locating information stored in records by searching an index.

Web pages are dispersed over millions of different computer systems around the world. Users of the Internet often desire to locate specific pages containing information of interest. The pages can be constructed using various formatting conventions, such as ASCII text, postscript files, html files, and Adobe Acrobat® files. The pages can include links to multimedia information content other than text, such as audio, graphics, and moving pictures.

In order to enable users to find information of interest in this vast expanse of information, search engines have been provided. These search engines typically have a query interface where the users specify terms and operators used to qualify their search parameters.

There are a number of problems with presenting pages located by searching an index to the Web. First, the number of pages accessible through the Web is very large, so the number of qualifying pages can also be large. In addition, queries may be loosely specified, thereby yielding many pages that may not be of interest to the users. The number of qualifying pages may number in the tens of thousands.

Accordingly, ranking systems have been introduced to order content retrieved from the Internet. Exemplary systems which rank content retrieved from the Internet are described in U.S. Pat. No. 6,317,741 to Burrows; U.S. Pat. No. 6,526,440 to Bharat, and U.S. Pat. No. 6,725,259 to Bharat, each of which is incorporated herein by reference in its entirety.

However, problems exist with current search engines. For example, such search engines only return information that is publicly accessible. If a user has placed access controls on information posted on the Internet, these search engines are unable to determine whether the requesting user has access to the content and retrieve the information. Indeed, the search engine is unable to even access the information.

In addition, the ranking process is essentially limited to the relevance of the content and other data contained in the retrieved information, such as whether the information is posted by a sponsor of the Web site hosting the search engine, metadata tags, and the like. Current search engines, whether used globally on the Internet or locally on a closed computer system, do not consider whether the person posting content has some relationship to the individual performing the search when returning results.

What is needed is a method and system for searching and retrieving content having access controls placed on the content by the posting user.

A need exists for a method and system for searching and retrieving content based on a characteristic of the user searching for the content.

A further need exists for a method and system of determining whether a relationship between a user posting content and a requesting user is sufficiently close to permit access to the content by the requesting user.

The present invention is directed towards solving one or more of these problems.

### SUMMARY

Before the present methods, systems, and materials are described, it is to be understood that this invention is not limited to the particular methodologies, systems and materials described, as these may vary. It is also to be understood that the terminology used in the description is for the purpose of describing the particular versions or embodiments only, and is not intended to limit the scope of the present invention which will be limited only by the appended claims.

It must also be noted that as used herein and in the appended claims, the singular forms “a,” “an,” and “the” include plural references unless the context clearly dictates otherwise. Thus, for example, reference to a “proximity threshold” is a reference to one or more proximity thresholds and equivalents thereof known to those skilled in the art, and so forth. Unless defined otherwise, all technical and scientific terms used herein have the same meanings as commonly understood by one of ordinary skill in the art. Although any methods, materials, and devices similar or equivalent to those described herein can be used in the practice or testing of embodiments of the present invention, the preferred methods, materials, and devices are now described. All publications mentioned herein are incorporated by reference. Nothing herein is to be construed as an admission that the invention is not entitled to antedate such disclosure by virtue of prior invention.

In an embodiment, a method of searching for content may include receiving one or more search terms from a user, selecting a plurality of information items each including at least one search term, determining, for at least one information item, a content supplier for the information item and a relationship index between the user and the content supplier, ordering the information items based, at least in part, upon the relationship index, and displaying a representation of at least one of the ordered information items.

In an embodiment, a system for searching for content may include a processor, a computer-readable storage medium in communication with the processor, a communications network in communication with the processor, and a plurality of computer systems in communication with the communications network. The computer-readable storage medium may contain one or more programming instructions for performing a method of searching for content. The method may include receiving one or more search terms from a user, selecting a plurality of information items each including at least one search term, determining, for at least one information item, a content supplier for the information item and a relationship index between the user and the content supplier, ordering the information items based, at least in part, upon the relationship index, and displaying a representation of at least one of the ordered information items.

### BRIEF DESCRIPTION OF THE DRAWINGS

The accompanying drawings, which are incorporated in and form a part of the specification, illustrate embodiments of the present invention and, together with the description serve to explain the principles of the invention. The embodiments illustrated in the drawings should not be read to constitute limiting requirements, but instead are intended to assist the reader in understanding the invention.

FIG. 1 depicts a flow diagram of an exemplary search process according to an embodiment.

FIG. 2 depicts an exemplary graphical user interface including a search window operating according to an embodiment.

FIGS. 3A and 3B depict an exemplary graphical user interface including a search results window according to an embodiment.

FIG. 4 depicts a block diagram of exemplary internal hardware that may be used to contain or implement the program instructions according to an embodiment.

### DETAILED DESCRIPTION

A relationship may be a set of one or more connections between a first user and a second user. Each connection may be a particular path connecting the first user and the second user. Exemplary connections between a first user and a second user may include the first user being, for example, a parent, co-worker, or friend of a friend of the second user. A connection may be either direct (i.e., no intervening users between the first user and the second user) or indirect (i.e., at least one intervening user between the first user and the second user). Each connection may include one or more direct connections (also known as “steps”). Each step may include a relationship designator (defined below). A tier may include a set of users who are an equal number of steps away from a particular user. In other words, a first user's second tier may include users who are two steps away from the first user.

In an embodiment, a user may assign one or more relationship designators to define one or more connections between the user and a contact. Additional or alternate user-defined and/or system-generated parameters may be used to define connections between two users, such as an unspecified connection, a weighted connection and the like. In an embodiment, a proximity index may be generated to define the strength of the relationship between two users based on such parameters.

Relationship Designators

User defined parameters for access control may include at least one relationship designator defining a connection between an individual and a contact (i.e., a first tier individual). Relationship designators may include one or more of familial relationship designators, friendship relationship designators, co-worker relationship designators and business associate relationship designators. Familial relationship designators may include, for example, wife, husband, mother, father, mother-in-law, father-in-law, daughter, son, daughter-in-law, son-in-law, sister, brother, sister-in-law, brother-in-law, grandmother, grandfather, granddaughter, grandson, cousin, second cousin, aunt, uncle, nephew, niece, stepmother, stepfather, stepsister, stepbrother, stepson, stepdaughter, ex-wife, ex-husband, friend of the family, distant relative, other relative and life partner. Friendship relationship designators may include, for example, fiancé, girlfriend, boyfriend, friend, roommate, neighbor, sorority sister, fraternity brother and classmate. Co-worker relationship designators may include, for example, co-worker, manager, employee and business partner. Business associate relationship designators may include, for example, vendor, supplier, client, contractor and business contact. In an embodiment, additional or alternate relationship designators and/or alternate or additional categories of relationship designators may be used. In an embodiment, relationship designators may be grouped in different categories.

In an embodiment, a relationship between two individuals may include more than one connection. For example, a user may be each of a friend, a fraternity brother, a classmate and a business partner of another user. In such an embodiment, a user may be permitted to enter a plurality of connections to appropriately describe the relationship between the user and an individual. The individual may be required to separately confirm each connection in order to describe the relationship between the user and the individual accurately.

In an embodiment, the user may select one or more relationship designators to an individual when adding the individual as a contact. The relationship designators assigned upon acceptance of the invitation to become a contact may be used to determine a proximity index between the user and the individual.

The individual may receive a message stating that the user would like to add the individual as a contact. In an embodiment, a second relationship designator may automatically be assigned based upon the relationship designator assigned by the user to the individual and the genders of each of the user and the individual. For example, a male user may assign a relationship designator of “girlfriend” to a female contact. Upon acceptance of the contact relationship by the female contact, a relationship designator of “boyfriend” may automatically be assigned to the male user in the female contact's social network. In an embodiment, corresponding relationship designators may be automatically assigned for a subset of all relationship designator types, such as familial relationships. In an embodiment, an individual may be permitted to assign his or her own relationship designators to a contacting user when accepting an invitation to form a relationship or after such acceptance.

In an embodiment, a relationship may be inferred based upon data transmitted by a user to another user. For example, if a user sends an electronic card to an individual, a relationship between the user and the individual may be recognized by a system. In an embodiment, a particular relationship may be inferred based on the content of the data. Continuing the above example, if the card is a birthday card that is designated for a brother, a sibling relationship may be inferred between the user and the individual.

A relationship designator may be combined with a tier designator (described below) to denote a relationship. For example, a user may state that content is available to all “second tier friends.” In an embodiment, the designation “second tier friends” may make content available to the friends of each of the user's contacts. In an alternate embodiment, the designation “second tier friends” may make content available to friends of each of the user's friends and, optionally, the user's friends. Additional designations and/or more particular designations may also be made.

Group Designators

User-defined parameters for access control may further include group designators. One or more users may be members of a group associated with a particular group designator. In an embodiment, group designators may be a subset of relationship designators. A group designator may operate as a user-defined relationship designator.

A user may create a group, assign a group designator to the group and invite other users to become members of the group. A user that controls the operation of the group is referred to herein as the “manager.” Other users in the group are referred to herein as “members.” The manager may also be a member. Users who have been invited to join the group are referred to herein as “pending members.”

In an embodiment, the manager may create the group and assign a group name to the group. Assigning the group name may further include assigning a group identifier. Once created, the manager may invite other users to become members of the group. A message may be transmitted to the pending members alerting them that the manager has requested their acceptance of group membership. Pending members may then accept or deny membership in the group. In an embodiment, members may be permitted to invite other users to join the group.

Group members may interact by sending messages or posting content to other group members. Groups may be created for any purpose. Exemplary groups may include, without limitation, scout troops, airplane enthusiasts, fraternity brothers, fans of a musical group and the like.

A user may combine a group designator with a tier designator (described below) to control access to user-specified content. For example, the user may state that the content is available to “my airplane enthusiast club's family.” In an embodiment, the designation “my airplane enthusiast club's family” may make content available to the family members of each member of the airplane enthusiast club. In an embodiment, the designation may also make content available to each member of the airplane enthusiast's club. Additional designations and/or more particular designations may also be made.

Tier Designators

A tier designator may represent the shortest distance between two individuals. For example, if a first user is a friend of a second user, who is the wife of a third user, who is a co-worker of a fourth user, then the first user may be in the third tier of the fourth user's social network. Likewise, the fourth user may be in the third tier of the first user's social network. However, if the first user is additionally the manager of a fifth user, who is a friend of the fourth user, then the first user and the fourth user may each be in the second tier of the other user's social network based on their relationship via the fifth user.

Tier designators may provide one measure used in determining a proximity index. In addition, tier designators may be combined with one or more relationship designators to assist in defining the strength of a relationship between two users. The use of tier designators in combination with relationship designators is described above.

Proximity Index

Proximity indices may be determined between users. A proximity index may be used to measure the strength of a relationship between two users.

Proximity indices may permit a user to manage control of his content by appropriately presenting content to the proper audience. Indeed, by properly assigning a proximity index, the user makes the content inherently more valuable. For example, a user may be more interested in purchasing items from a person known to him or known by a friend than from a stranger. Moreover, a restaurant review in a newspaper may be less persuasive than a similar review from a user's contact.

The strength of the relationship between two users may depend on the type(s) of relationship(s) between the users. For example, the relationship between a user and the user's brother may be qualitatively stronger than the relationship between a user and a user's business associate. Accordingly, a generated proximity index for the relationship between the user and the user's brother may be determined to be greater than a generated proximity index for the relationship between the user and a user's business associate.

The strength of the relationship between two users may also depend upon the number of steps between the users. As the number of steps between two users increases, the connection between the users may be determined to be more tenuous. For example, the relationship between a user and the user's business associate may be stronger than the relationship between the user and the user's brother's business associate. However, it is not always the case that additional steps make a relationship more tenuous. For example, the relationship between a user and a user's business associate may be weaker than the relationship between the user and the user's brother's wife. Accordingly, simply analyzing tier relationships may not be sufficient to determine the proximity index for a relationship because the nature of each connection between two users may be important to determining the proximity index.

The strength of the relationship between two users may also depend on the number of connections between the users. For example, the relationship between a user and a user's friend may be weaker than the relationship between the user and a user's friend who is also the user's business partner. Thus, additional connections between the user and a member may denote that a user has a closer relationship with that member than with a member possessing a subset of the connections.

Moreover, the strength of the relationship between two users may depend upon whether the two users are members of the same group. Two users who are each members of a private group may have a stronger relationship than two users who are members of a public group. Similarly, two users who are each members of a group with relatively few members may have a stronger relationship than two users who are each members of a group with more members.

Furthermore, if two users communicate or communicate frequently, it may be determined that the two users have a strong relationship. Conversely, if two users do not communicate, the relationship may be determined to be weak. Additionally, if shared contacts of the two users communicate or the two users each communicate with a shared contact, the relationship may be deemed stronger.

In an embodiment, one or more of these factors may be considered in determining a proximity index. The above-listed comparisons and factors are exemplary only. Alternate and/or additional factors may be considered in determining a proximity index between two users.

In an embodiment, the proximity index may be a numerical value between 0 and 1, inclusive. In an embodiment, a proximity index of 1 may represent the relationship of a user to himself and may not be achievable between two distinct users.

Ranges of numerical proximity indices may be mapped to a proximity index grouping having a user-discernable label. In an embodiment, a proximity index between 0.800 and 0.999 may map to a proximity index grouping having a label of “Very Close;” a proximity index between 0.600 and 0.799 may map to a proximity index grouping having a label of “Close;” and a proximity index between 0.400 and 0.599 may map to a proximity index grouping having a label of “Distant.” In an embodiment, a proximity index grouping containing relationships having a proximity index less than 0.400 may not receive a label because the relationships are too tenuous. The above-listed ranges, groupings and labels are exemplary only. Any ranges, number of groupings and/or grouping labels may be used for the proximity index groupings.

Search Algorithm

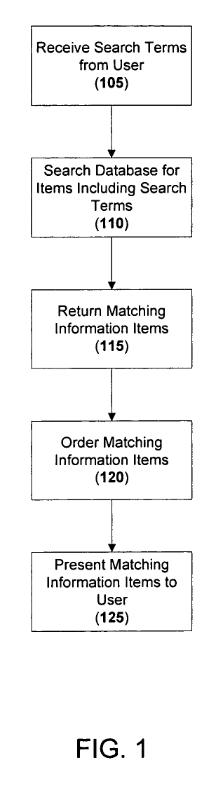

FIG. 1 depicts a flow chart of an exemplary search process according to an embodiment. As shown in FIG. 1, one or more search terms pertaining to content, such as information items, for which a user wishes to search may be received 105 from the user. In an embodiment, a search algorithm may then search 110 for information items within a database containing the search terms. Searching 110 the database may include determining whether the user may access each information item. Accessibility of the information item to the user may depend upon one or more of the following factors, without limitation: the user's proximity index with respect to the individual that posted the information (i.e., the “content supplier”), one or more relationship designators defining the relationship between the user and the content supplier, one or more tier designators defining the number of individuals between the user and the content supplier, and one or more group designators defining whether the user and the content supplier are in the same or a similar group. In an embodiment, information that is not determined to be accessible may not be examined with respect to the search terms.

The search may return 115 information items that the user may access while excluding information items that the user may not access. In an embodiment, information that is not publicly available may be returned 115 to the user as a result of the search based on one or more of the above-listed metrics. In an embodiment, information items that do not meet a threshold may be excluded from the returned information items. For example, a user may limit a search to return information items that are posted only by direct contacts. In an embodiment, a threshold may be placed on an information item by the content supplier. For example, the content supplier may only allow searches performed by users who are direct contacts to return the information item. Either the user or the content supplier may also set other thresholds to limit the search results.

In an embodiment, the search may return 115 one or more of, for example, text information items, graphics information items, audio information items, and video information items. In an embodiment, information items may be separated into different search result groups based on the content of the information item. For example, the information items may be grouped into one or more content types, such as messages, photos, journals, events, reviews, marketplace items, recipes, links, Web content, graphical items, textual items, audible items, and/or the like. In an embodiment, the returned information items may be limited to content within one or more content types, such as the ones listed above.

When the search has completed, the resulting information may be ordered 120 based on one or more factors. For example, the information may be ordered 120 based on one or more of the following: the number of occurrences of a search term in a returned information item, the proximity index between the user and the content supplier for a returned information item, one or more tier designators defining the number of individuals between the user and the content supplier for a returned information item, one or more relationship designators defining the relationship between the user and the content supplier for a returned information item, one or more groups designators defining whether the user and the content supplier for a returned information item are in the same or a similar group, and the date on which the content supplier posted a returned information item.

The ordered information items may then be presented 125 to the user. In an embodiment, a representation of the ordered information items may be presented 125. In an embodiment, the representation may include, for example, a Uniform Resource Locator, a segment of the information item containing a search term, a time at which the content supplier posted the information item, a name of the content supplier, a relationship between the user and the content supplier, a description of the content type of the information item, and/or a description of the content of the information item. If an audio information item is returned, the representation of the audio information item may include, for example, an audible presentation of the audio information item. If a video information item is returned, the representation of the video information item may include, for example, an audiovisual presentation of the video information item.

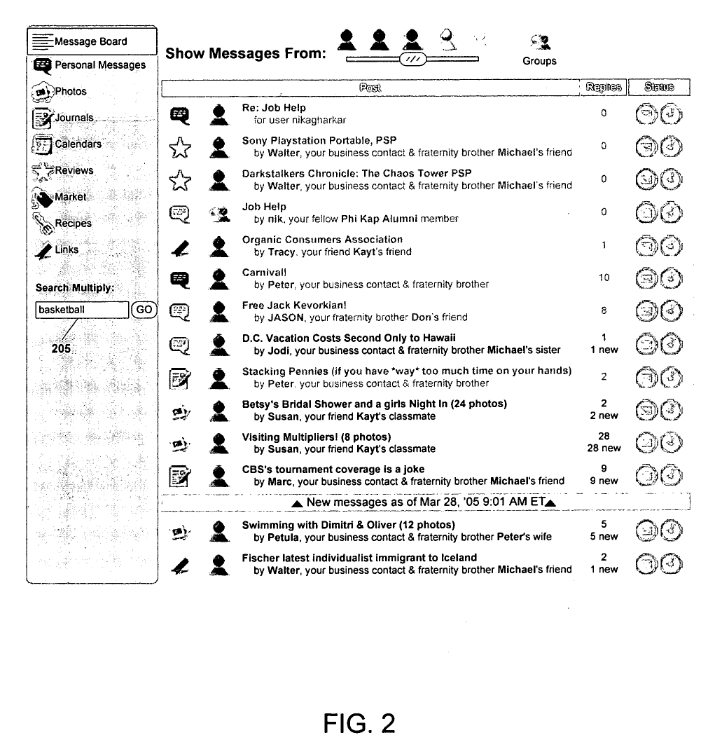

FIG. 2 depicts an exemplary graphical user interface including a search window operating according to an embodiment. In an embodiment, a user may perform a search by entering a search term into a search pane 205. As shown in FIG. 2, a global search may be performed. In an embodiment, a sub-category of search items may be selected. For example, search item sub-categories may include, without limitation, personal messages, photos, journals, calendar items, reviews, marketplace items, recipes, URL links, textual items, graphical items, and/or audible items. In an embodiment, additional and/or alternate search item sub-categories may be used to refine a search.

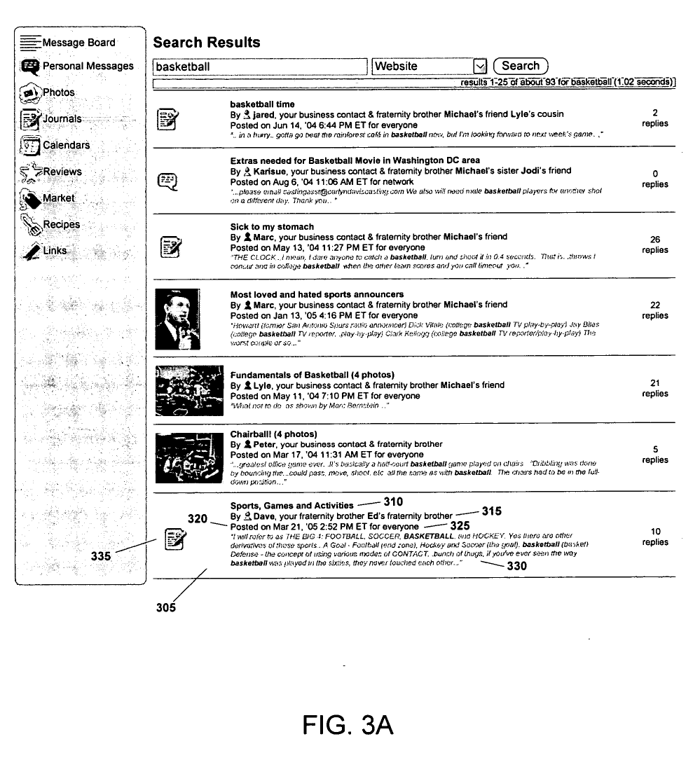

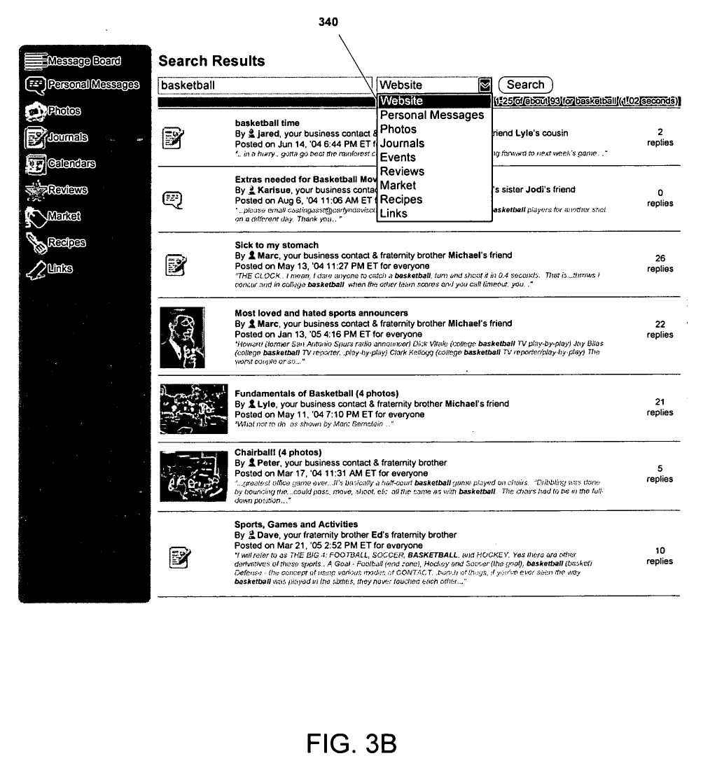

FIGS. 3A and 3B depict an exemplary graphical user interface including a search results window according to an embodiment. As shown in FIG. 3A, the returned information items, such as 305, may be displayed in a tabular format. Each information item 305 may include data pertaining to the information item. For example, each information item 305 may include a title and/or link 310 to the information item, a relationship description 315, a date 320 when the information item was posted, an access control group 325 for which the information item is available (if any), an excerpt 330 that, for example, includes one or more search terms used in the information item, and a information item type designator 335.

The title/link 310 may enable the user to view the entire returned information item 305. For example, the user may select the title/link 310 to retrieve information located at a Uniform Resource Locator associated with the title/link.

The relationship description 315 may include a description of the relationship between the searching user and the content supplier (if the relationship is determined during the search process). Additionally or alternatively, one or more of the proximity index, tier designators, and/or group designators may be displayed in place of or in addition to the relationship description 315.

The date 320 may be displayed in any recognizable format if a date is displayed at all.

An access control group 325 may be used to limit the users to which the information item 305 is available. In an embodiment, if the access control group 325 is set to, for example, “everyone,” the information item 305 may be publicly available. In contrast, if the access control group 325 is set to, for example, “network” or “contacts,” the information may only be available to those individuals that are within the content supplier's “network” or “contacts,” respectively. In an embodiment, no access control group 325 may be assigned to a particular information item 305. In this case, the information item 305 may be publicly available. Other designations for the access control group 325 may also be used within the scope of this disclosure. The above designations are merely exemplary.

The excerpt 330 may include information extracted from the information item 305. In an embodiment, the excerpt 330 may include portions of the information item 305 that include one or more of the search terms.

The information item type designator 335 may depict the type of information that is included in the information item. In an embodiment, if the information item 305 includes one or more graphical items, a depiction of at least one of the graphical items may be included as the information item type designator 335.

FIG. 3B depicts an information item menu. As shown in FIG. 3B, the information item menu 340 may include one or more classifications for types of information items, such as 305. For example, the information item menu 340 may include, for example, the entire website, personal messages, photos, journals, events, reviews, marketplace items, recipes, and links. Other menu entries may also be used within the scope of this disclosure. The above menu entries are merely exemplary.

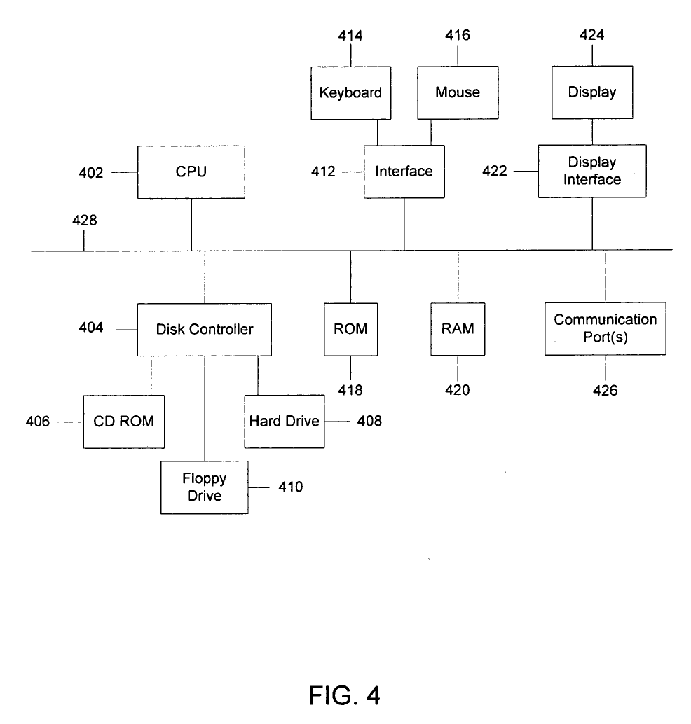

FIG. 4 is a block diagram of exemplary internal hardware that may be used to contain or implement the program instructions according to an embodiment. Referring to FIG. 4, a bus 428 serves as the main information highway interconnecting the other illustrated components of the hardware. CPU 402 is the central processing unit of the system, performing calculations and logic operations required to execute a program. Read only memory (ROM) 418 and random access memory (RAM) 420 constitute exemplary memory devices.

A disk controller 404 interfaces with one or more optional disk drives to the system bus 428. These disk drives may be external or internal floppy disk drives such as 410, CD ROM drives 406, or external or internal hard drives 408. As indicated previously, these various disk drives and disk controllers are optional devices.

Program instructions may be stored in the ROM 418 and/or the RAM 420. Optionally, program instructions may be stored on a computer readable medium such as a floppy disk or a digital disk or other recording medium, a communications signal or a carrier wave.

A display interface 422 may permit information from the bus 428 to be displayed on the display 424 in audio, graphic or alphanumeric format. Communication with external devices may optionally occur using various communication ports 426. An exemplary communication port 426 may be attached to a communications network, such as the Internet or an intranet.

In addition to the standard computer-type components, the hardware may also include an interface 412 which allows for receipt of data from input devices such as a keyboard 414 or other input device 416 such as a remote control, pointer and/or joystick.

An embedded system may optionally be used to perform one, some or all of the operations described herein. Likewise, a multiprocessor system may optionally be used to perform one, some or all of the operations described herein.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A method of searching for content, the method comprising:
receiving one or more search terms from a user;
selecting a plurality of information items, wherein each selected information item includes at least one search term;
for at least one information item:
determining a content supplier for the information item, and
determining a relationship index between the user and the content supplier; and
presenting a representation of at least one of the selected information items.

2. The method of claim 1 wherein the relationship index comprises a proximity index between the user and the content supplier.

3. The method of claim 2 wherein the proximity index is determined based at least in part on one or more of the following:
a number of tiers between the user and the content supplier;
a type of relationship designator defining a relationship between the user and the content supplier;
a number of connections between the user and the content supplier;
the user being a first member of a group and the content supplier being a second member of the group;
a number of members of a group of which the user and the content supplier are members;
one or more communications between the user and the content supplier;
one or more first communications between the user and a second user and one or more second communications between the content supplier and the second user; and
the user being a member of an access control group.

4. The method of claim 1 wherein the relationship index comprises an index based at least in part on one or more relationship designators defining a relationship between the user and the content supplier.

5. The method of claim 4 wherein the index is based at least in part on a type of relationship designator for at least one relationship designator defining the relationship between the user and the content supplier.

6. The method of claim 1 wherein the relationship index comprises an index based at least in part on a tier designator defining a number of individuals in a connection between the user and the content supplier.

7. The method of claim 1 wherein the relationship index comprises an index based at least in part on one or more group designators defining whether the user and the content supplier are each members of a group.

8. The method of claim 1 wherein each selected information item includes each search term.

9. The method of claim 1 wherein an information item comprises a text information item.

10. The method of claim 1 wherein an information item comprises a graphic information item.

11. The method of claim 1 wherein an information item comprises an audio information item.

12. The method of claim 1 wherein an information item comprises a video information item.

13. The method of claim 1, further comprising:
ordering the selected information items based, at least in part, on the relationship index.

14. The method of claim 13 wherein ordering the selected information items is further based, at least in part, on one or more of the following:
a number of occurrences of a search term in the information item; and
a date when the content supplier posted the information item.

15. The method of claim 1, further comprising:
determining whether the user has permission to access to at least one information item.

16. The method of claim 13 wherein determining whether the user has permission to access is based on one or more of the following:
a proximity index between the user and the content supplier;
one or more relationship designators defining a relationship between the user and the content supplier;
a tier designator defining a number of individuals in a connection between the user and the content supplier; and
one or more group designators defining whether the user and the content supplier are each members of a group.

17. The method of claim 13 wherein selecting one or more information items further comprises selecting only information items for which the user has permission to access.

18. The method of claim 1 wherein selecting one or more information items further comprises selecting only information items having a particular content type.

19. The method of claim 1 wherein the representation comprises one or more of the following:
a Uniform Resource Locator;
an excerpt from the information item;
a time at which the content supplier posted the information item;
a name of the content supplier;
a relationship between the user and the content supplier;
a description of the content type of the information item;
a description of the content of the information item; and
an audible presentation of the information item.

20. A system for searching for content, the system comprising:
a processor;
a computer-readable storage medium in communication with the processor;
a communications network in communication with the processor; and
a plurality of computer systems in communication with the communications network,
wherein the computer-readable storage medium contains one or more programming instructions for performing a method of searching for content, the method comprising:
receiving one or more search terms from a user,
selecting a plurality of information items, wherein each selected information item includes at least one search term,
for at least one information item:
determining a content supplier for the information item, and
determining a relationship index between the user and the content supplier, and
presenting a representation of at least one of the selected information items.

21. The system of claim 20, wherein the processor-readable storage medium further contains one or more programming instruction for performing the following:
ordering the selected information items based, at least in part, on the relationship index.

22. The system of claim 20, wherein the processor-readable storage medium further contains one or more programming instruction for performing the following:
determining whether the user has access to at least one information item.
